(19) United States
(12) Patent Application Publication
(10) Pub. No.: US 2025/0118039 A1
(43) Pub. Date: Apr. 10, 2025

(54) IDENTIFYING FACIAL LANDMARK LOCATIONS FOR AI SYSTEMS AND APPLICATIONS

(71) Applicant: NVIDIA Corporation, Santa Clara, CA (US)

(72) Inventor: Yeongho Seol, Seoul (KR)

(21) Appl. No.: 18/483,697

(22) Filed: Oct. 10, 2023

(51) Int. Cl. G06T 19/20; G06T 7/70; G06T 13/40; G06V 10/25; G06V 40/16

(52) U.S. Cl. CPC G06T 19/20; G06T 7/70; G06T 13/40; G06V 10/25; G06V 40/171; G06T 2207/30201; G06T 2219/2004; G06T 2219/2016; G06T 2219/2021; G06V 2201/07

(57) ABSTRACT

In various examples, landmark identification and retargeting for AI systems and applications is described herein. Systems and methods are disclosed that use a first three-dimensional (3D) face (e.g., a morphable model mesh) that is already associated with locations of facial landmarks to determine locations of corresponding facial landmarks on a second 3D face (e.g., a target face mesh). To determine the locations, one or more iterations of transformation processes and/or fitting processes may be performed on the first 3D face in order to morph the landmarks of the first 3D face to align with second landmarks on the second 3D face. After performing the iteration(s) of the transformation processes and/or the fitting processes, closest locations (e.g., vertices) on the second 3D face from the landmark locations (e.g., vertices) on the first 3D face are identified and used as the locations of the corresponding facial landmarks on the second 3D face.

### BACKGROUND

Many applications, such as gaming applications, interactive applications, communications applications, multimedia applications, and/or the like, use animated characters or digital avatars (humanlike or otherwise) that interact with users of the applications and/or other animated characters within the applications. In order to provide more realistic experiences for the users, some animated characters interact using both audio, such as speech, as well as visual indicators. For example, when an animated character is interacting with a user, an application may both sync the lip movements of the animated character with speech being output by the animated character while also causing the animated character to visually express emotions using facial/head movements. Visually expressing facial emotions may include causing the animated character to move various features of the face, such as the eyes, the eyebrows, the forehead, the face, the nose, the cheeks, and/or other features of the face.

As such, many approaches have been developed to determine locations of various landmarks on an animated face, such as lips, eyes, a nose, ears, cheeks, hairlines, jawlines, and/or the like, where the landmarks are then used for animation. For instance, these approaches use models to initially perform two-dimensional (2D) landmark detection on an animated character and then use a camera to project the landmarks on the animated character. While such approaches provide accurate results for landmark detection in some circumstances, such as when an animated character includes a regular human face for which the models are trained, the accuracies of these approaches are reduced in other circumstances, such as when there are different camera angles with respective to the animated character, the illumination changes, and/or the animated character does not include much texture. Additionally, these approaches are inaccurate for certain types of animated characters, such as cartoon characters and/or animated faces for which the models are not trained. For example, when attempting to transfer learned facial movements of a human-like avatar to a cartoonish avatar, the landmark points corresponding to the human-like avatar may not align well with corresponding features of the cartoonish avatar. As a result, the transfer of the facial landmarks may be wholly inaccurate, thus resulting in an extensive amount of human effort to rearrange and realign the facial landmarks on the cartoonish avatar.

### SUMMARY

Embodiments of the present disclosure relate to identifying facial and/or other landmark locations for AI systems and applications. Systems and methods are disclosed that use a first three-dimensional (3D) face (e.g., a morphable model mesh) that is already associated with locations of facial landmarks to determine locations of corresponding facial landmarks on a second 3D face (e.g., a target face mesh, also referred to as a “target face”). To determine the locations, one or more iterations of one or more fitting processes (e.g., one or more 3D morphable model fitting processes) may be performed on the first 3D face in order to morph the first 3D face to be similar to the second 3D face. For instance, a first fitting process may include rigid transformation (e.g., translation, rotation, scale, etc.) of the first 3D face in order to align the first 3D face with respect the second 3D face. Additionally, a second fitting process may include optimizing a weighted point distance between the first 3D face and the second 3D face. After performing the iteration(s) of the fitting processes, closest locations (e.g., vertices) on the second 3D face from the landmark locations (e.g., vertices) on the first 3D face are identified and used as the locations of the corresponding facial landmarks on the second 3D face.

In contrast to conventional systems, such as those that rely on 2D to 3D conversion of landmarks, the systems and methods of the present disclosure are better able to perform landmark detection on the target face by morphing the first 3D face to the target face, using the processes described herein. For instance, the conventional systems use the models that are trained on specific human faces to perform the 2D landmark detection. As such, these models are less accurate when processing faces from different camera angles, with different illuminations, and/or when the animated characters do not include texture. Additionally, these models are less accurate when processing other types of faces for which the models were not trained, such as cartoon character faces. In contrast, by initially morphing the first 3D face to the target face, the current systems, in some embodiments, are still able to perform landmark detection with high accuracy when camera angles change, illumination changes, animated characters do not include texture, and/or for new types of animated characters, such as cartoon characters.

### BRIEF DESCRIPTION OF THE DRAWINGS

The present systems and methods for identifying facial and/or other landmark locations for AI systems and applications are described in detail below with reference to the attached drawing figures, wherein:

FIG. 1A illustrates an example data flow diagram for a process of automatically identifying landmark locations on faces, in accordance with some embodiments of the present disclosure;

FIG. 1B illustrates an example data flow diagram for a process of interactively identifying landmark locations on faces, in accordance with some embodiments of the present disclosure;

FIG. 2A illustrates an example of a morphable face, in accordance with some embodiments of the present disclosure;

FIG. 2B illustrates an example of a target face for determining landmark locations, in accordance with some embodiments of the present disclosure;

FIG. 3 illustrates an example of orienting a first face with respect to a second face, in accordance with some embodiments of the present disclosure;

FIG. 4 illustrates an example of aligning a first face with respect to a second face using bounding shapes, in accordance with some embodiments of the present disclosure;

FIG. 5 illustrates an example of indicating one or more marker locations associated with one or more landmarks on a face, in accordance with some embodiments of the present disclosure;

FIGS. 6A-6B illustrate examples of performing multiple iterations of rigid transformation and structure fitting to cause a first face to better represent a second face, in accordance with some embodiments of the present disclosure;

FIG. 7 illustrates an example of determining landmark locations on a second face using landmark locations on a first face, in accordance with some embodiments of the present disclosure;

FIG. 8 illustrates an example of indicating marker locations associated with landmarks on a face, in accordance with some embodiments of the present disclosure;

FIG. 9 illustrates an example of using marker locations to deform a first face to represent a second face, in accordance with some embodiments of the present disclosure;

FIG. 10 illustrates a flow diagram showing a method for identifying landmark locations on faces, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Systems and methods are disclosed related to identifying landmark locations on avatars, digital characters, and/or other actors or objects for AI systems and applications. Although primarily described with respect to facial landmark identification and/or transfer (e.g., from one “face” to another “face”), this is not intended to be limiting, and landmarks for other features (e.g., arms, legs, torso, etc., as well as non-body related landmarks) may be identified and/or transferred without departing from the scope of the present disclosure.

With respect to an implementation for faces, for instance, a system(s) may receive, obtain, generate, and/or retrieve first data representing a first three-dimensional (3D) face (also referred to as just the “first face”) that is associated with locations of landmarks. As described herein, the first face may correspond to a morphable model face where the locations of the landmarks are already known, such as by using user input, machine learning, and/or any other technique for determining landmark locations on faces. Additionally, the landmarks may be associated with features of a face such as, but not limited to, one or more eye features (e.g., the tops of the eyes, the bottoms of the eyes, the sides of the eyes, the middles of the eyes), one or more lip features (e.g., the top of the lips, the bottom of the lips, the sides of the lips, the middle of the lips, etc.), one or more cheek features, one or more nose features, one or more ear features, one or more chin features, one or more hairline features, one or more forehead features, and/or any other features of a face (or other feature or body part).

The system(s) may also receive, obtain, generate, and/or retrieve second data representing a second 3D face (also referred to as just the “second face” or a “target face”) for which corresponding locations of the landmarks are to be determined. In some examples, the second face may include a similar structure as the first face. For example, the second face and the first face may both include human faces that include similar features, such as mouths, eyes, noses, chins, cheeks, ears, and/or so forth. However, in other examples, the second face may include a different structure as compared to the first face. For example, the second face may include a cartoon character face while the first face again includes a human face. In such an example, the second face may not include one or more features of the first face, such as the nose or one of the eyes. In any of these examples, the system(s) may then process the second face with respect to the first face to determine the locations of the landmarks.

For instance, the system(s) may initially align the first face with respect to the second face. In some examples, the system(s) aligns the first face with respect to the second face by causing an orientation of the first face to match an orientation of the second face. In such examples, the system(s) may match the orientations using directions associated with the faces. For example, a user may indicate and/or the system(s) may automatically determine directions that are outwards from the faces (e.g., indicating the forward directions of the faces) and/or outwards from the tops of the heads associated with the faces and then use these directions to match the orientations. The system(s) may also initially scale the first face with respect to the second face. For example, the system(s) may determine a first bounding shape (e.g., a first bounding box) associated with the first face and a second bounding shape (e.g., a second bounding box) associated with the second face. As described herein, a bounding shape may include dimensions in at least three directions, such as the x-direction, the y-direction, and the z-direction. The system(s) may then scale the first face with respect to the second face by scaling the first bounding shape to match the second bounding shape.

In some examples, the system(s) may use one or more additional and/or alternative processes to further align the first face with respect to the second face. For instance, the system(s) may receive one or more inputs indicating one or more locations (e.g., one or more guide points) of one or more landmarks associated with the second face. For example, the system(s) may receive an input indicating a location of a nose (and/or feature of the nose), a location of an eye (and/or feature of the eye), a location of a mouth (and/or feature of the mouth), and/or the like on the second face that matches a corresponding location(s) of a corresponding landmark(s) of the first face. In some examples, the system(s) may further deform the first face based at least on the indicated location(s) of the landmark(s). For instance, the system(s) may move the location(s) of the landmark(s) associated with the first face to match the indicated location(s) of the landmark(s) on the second face.

The system(s) may then perform one or more iterations of one or more processes in order to morph the first face to be similar to the second face. For instance, the system(s) may perform a first process that includes rigid transformation where the first face is translated, rotated, and/or scaled to better represent the second face. In some examples, the system(s) uses one or more functions to perform the rigid transformation. The system(s) may then perform a second process that includes model fitting where the structure of the first face is updated in order to better represent the second face. For instance, the model fitting may include updating one or more vertex locations associated with the first face to match one or more vertex locations associated with the second face. Additionally, in some examples, the system(s) may use one or more functions to perform the model fitting. In some embodiments, without limitation, the model fitting may include one or more 3D morphable model fitting processes.

The system(s) may then continue to repeat performing the rigid transformation and/or the model fitting using a number of iterations. In some examples, the system(s) may determine the number of iterations using one or more techniques. For a first example, the system(s) may use a set number of iterations such as, but not limited to, one iteration, two iterations, five iterations, ten iterations, and/or any other number of iterations. For a second example, the system(s) may determine the number of iterations based on the results associated with the functions. For instance, the system(s) may continue to perform the rigid transformation and/or the model fitting until a first value associated with the first function for the rigid transformation and/or a second value associated with the second function for the model fitting satisfies (e.g., are less than or equal to) one or more threshold values. In any example, after performing these processes, the first face may substantially represent the second face. For example, the translation, the rotation, the scale, and/or the shape of the first face may substantially match the translation, the rotation, the scale, and/or the shape of the second face.

The system(s) may then use the locations of the landmarks on the first face to determine locations of corresponding landmarks on the second face. For instance, the system(s) may use the locations of the eye feature(s), the lip feature(s), the cheek feature(s), the nose feature(s), the ear feature(s), the chin feature(s) and/or the like on the first face to determine the locations of the eye feature(s), the lip feature(s), the cheek feature(s), the nose feature(s), the ear feature(s), the chin feature(s) and/or the like on the second face. In some examples, the system(s) may perform one or more techniques for determining the locations of the corresponding landmarks on the second face.

For example, and for a landmark, the system(s) may determine a point on the second face that is located proximate to a landmark point on the first face. In some examples, the system(s) may determine that the point is located proximate to the landmark point based at least on the point including a closest point on the second face as compared to the landmark point. Additionally, or alternatively, in some examples, the system(s) may determine that the point is located proximate to the landmark point based at least on the point being within a threshold distance to the landmark point. The system(s) may then determine a first normal direction associated with the point and a second normal direction associated with the landmark point. Additionally, the system(s) may determine that the point corresponds to the landmark point when the first normal direction is within a threshold angle (e.g., 10 degrees, 30 degrees, 45 degrees, 70 degrees, etc.) to the second normal direction or determine that the point does not correspond to the landmark point when the first normal direction is outside of the threshold angle to the second normal direction.

If the system(s) determines that the point corresponds to the landmark point, then the system(s) may determine a landmark that is located at the landmark point on the first face is also located at the point on the second face. However, if the system determines that the point does not correspond to the landmark point, then the system(s) may perform one or more similar processes using one or more additional points on the second face (e.g., using a next closest point). The system(s) may then continue to perform similar processes using the locations of the landmarks on the first face to continue determining the corresponding locations of the landmarks on the second face. Additionally, the system(s) may output data representing the locations of the landmarks on the second face.

In some examples, the system(s) may further use one or more techniques to verify the locations of the landmarks on the second face. For example, a user device may receive the output data and, using the output data, display content indicating the locations of the landmarks. For instance, the content may include the second face showing the locations of the landmarks. A user may then use the user device to update one or more of the locations if one or more of the locations are not accurate. For example, if a landmark that is associated with a side of the mouth is indicated as being located in the middle of the mouth, then the user may move the landmark location to the side of the mouth. The system(s) may then receive data from the user device, where the data represents any changes made to the locations of the landmarks on the second face, and update the locations of the landmarks on the second face based at least on the data.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems implementing one or more large language models (LLMs), systems for performing conversational AI operations, systems for performing light transport simulation, systems for performing collaborative content creation for 3D assets, a system for performing generative AI operations, systems implemented at least partially using cloud computing resources, and/or other types of systems.

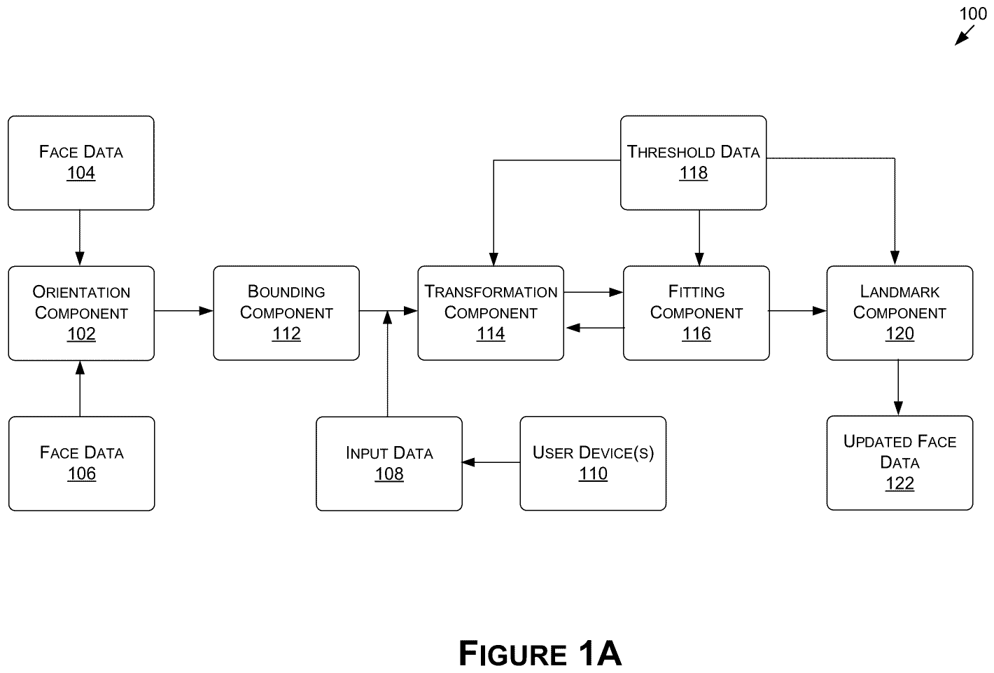

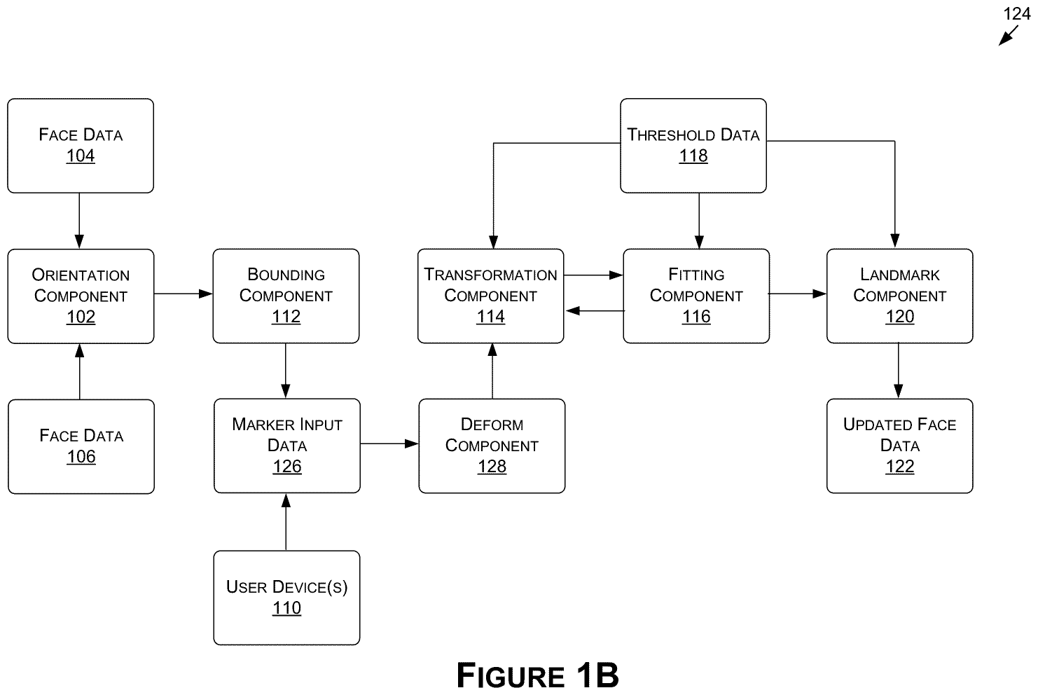

With reference to FIG. 1A, FIG. 1A illustrates an example data flow diagram for a process of identifying landmark locations-specifically on faces, in this example—in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include an orientation component 102 receiving first face data 104 representing a first three-dimensional (3D) face (also referred to as just the “first face” or a “morphable face”) that is associated with locations of landmarks. As described herein, the first face may correspond to a morphable model face where the locations of the landmarks are already known, such as by using user input, machine learning, and/or any other technique for determining landmark locations on faces. Additionally, the landmarks may be associated with features of the first face such as, but not limited to, one or more eye features (e.g., the tops of the eyes, the bottoms of the eyes, the sides of the eyes, the middles of the eyes), one or more lip features (e.g., the top of the lips, the bottom of the lips, the sides of the lips, the middle of the lips, etc.), one or more cheek features, one or more nose features, one or more ear features, one or more chin features, and/or any other features of a face.

In some examples, the first face data 104 may represent the first face as a collection of points (e.g., vertices) located on the first face. For example, the first face data 104 may represent coordinates associated with the points, such as the x-coordinate locations, the y-coordinate locations, and/or the z-coordinate locations associated with the points. Additionally, the locations of the landmarks may be associated with the points and/or coordinates. For a first example, a location of a landmark may be associated with a point on the first face that includes the feature corresponding to the landmark. For a second example, a location of a landmark may be associated with coordinates, such as a x-coordinate location, a y-coordinate location, and/or a z-coordinate location.

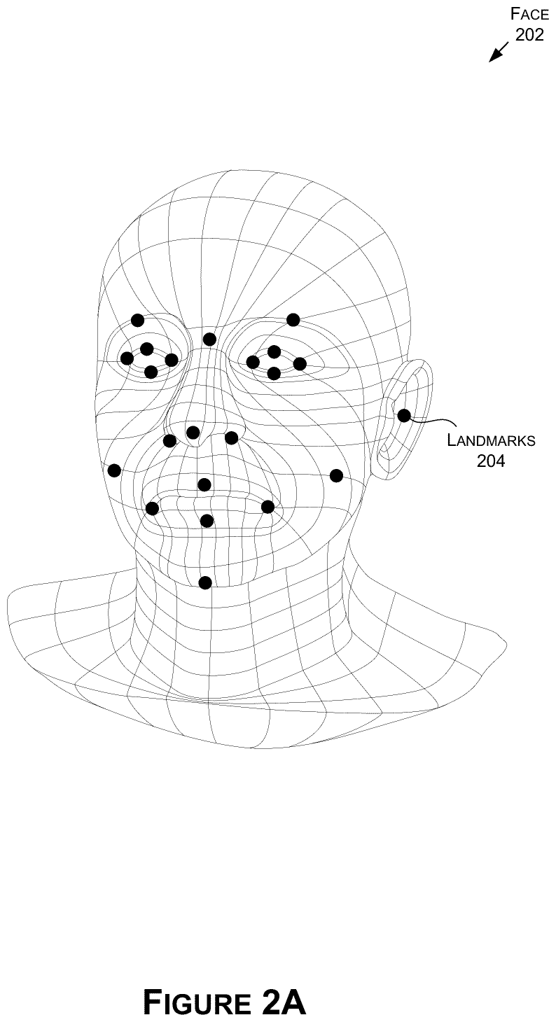

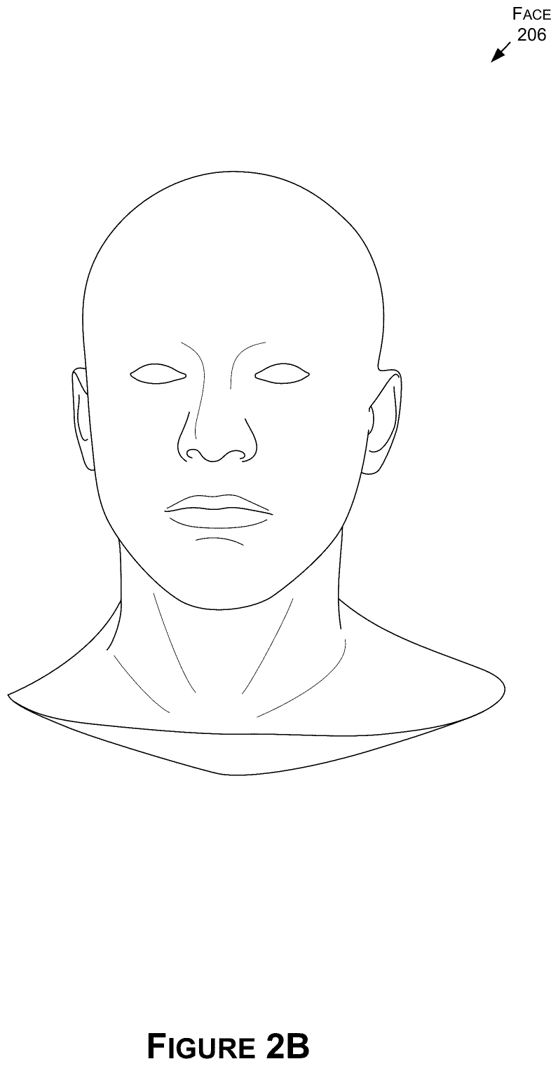

For instance, FIG. 2A illustrates an example of a morphable face 202 (e.g., the first face described herein), in accordance with some embodiments of the present disclosure. As shown, the first face 202 may include a number of locations for a number of landmarks 204 (although only one is labeled for clarity reasons). For instance, the landmarks 204 may be associated with a mouth (e.g., the bottom, sides, and top of the mouth), cheeks, a chin, a nose (e.g., the middle and sides of the nose), a first eye (e.g., the bottom, sides, and top of the left eye), a second eye (e.g., the bottom, sides, and top of the right eye), a center between the eyes, eyebrows, and ears. While the example of FIG. 2A illustrates a few locations of a few landmarks 204 associated with the first face 202, in other examples, the first face 202 may be associated with additional and/or alternative landmarks.

Referring back to the example of FIG. 1A, the process 100 may also include the orientation component 102 receiving second face data 106 representing a second 3D face (also referred to as just the “second face” or a “target face”) for which corresponding locations of the landmarks are to be determined. In some examples, the second face may include a similar structure as the first face. For example, the second face and the first face may both include human faces that include similar features, such as mouths, eyes, noses, chins, cheeks, ears, and/or so forth. However, in other examples, the second face may include a different structure as compared to the first face. For example, the second face may include a cartoon character face while the first face again includes a human face. In such an example, the second face may not include one or more features of the first face, such as the nose or one of the eyes. In some examples, and similar to the first face data 104, the second face data 106 may represent the second face as a collection of points (e.g., vertices) located on the second face. For example, the second face data 106 may represent coordinates associated with the points, such as the x-coordinate locations, the y-coordinate locations, and/or the z-coordinate locations associated with the points.

For instance, FIG. 2B illustrates an example of a target face 206 (e.g., the second face described herein) for determining landmark locations, in accordance with some embodiments of the present disclosure. As shown, the second face 206 may be similar to the first face 202 in that the second face 206 and the first face 202 both include human faces. For instance, the second face 206 may include similar features as the first face 202 such as, but not limited to, lips, a nose, cheeks, a chin, eyes, ears, eyebrows, and/or the like. However, in other examples, a second, target face may include a different type of face as compared to the first face 202. For example, a second face may include a cartoon face (e.g., an animal face, an alien face, a cartoonish face, a robot face, etc.) that does not include one or more of the features of the first face 202.

Referring back to the example of FIG. 1A, the process 100 may include the orientation component 102 orienting the first face with respect to the second face. As described herein, in some examples, the orientation component 102 may orient the faces using one or more directions associated with the faces. For example, the orientation component 102 may orient the faces based at least on matching one or more first directions associated with the first face to one or more second directions associated with the second face. As described herein, a direction may include, but is not limited to, a direction of a face, a direction of a top of a head associated with the face, a direction of an ear, and/or any other direction. In some examples, the orientation component 102 may determine the directions using input data 108 received from one or more user devices 110. For instance, the input data 108 may represent the directions as indicated by one or more users. Additionally, or alternatively, in some examples, the orientation component 102 may determine the directions based on processing the faces, such as by using one or more models that are trained to determine the directions.

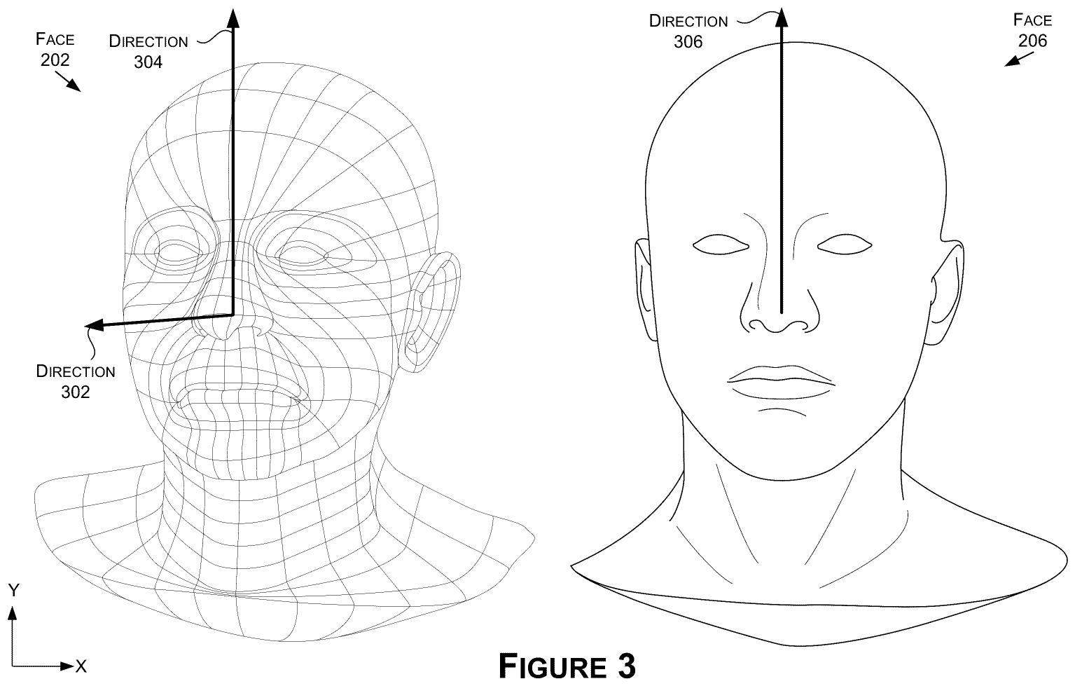

For instance, FIG. 3 illustrates an example of orienting the first face 202 with respect to the second face 206, in accordance with some embodiments of the present disclosure. As shown, the orientation component 102 may determine at least a lateral direction 302 (e.g., along x-axis) and a vertical direction 304 (e.g., along y-axis) associated with the first face 202, as well as a forward or inward direction (e.g., along a z-axis, which is not illustrated since it is directed outwards in the example of FIG. 3), and then a vertical direction 306 (and/or lateral, and/or inward/outward direction) associated with the second face 206. As described herein, in some examples, the orientation component 102 determines one or more of the directions 302, 304, or 306 based at least on receiving one or more inputs from one or more users. In some examples, the orientation component 102 determines one or more of the directions 302, 304, or 306 based at least on processing the faces 202 and 204, such as by using one or more models. In any example, the orientation component 102 may then orient the first face 202 with respect to the second face 206 using the directions 302, 304, and 306, such as by aligning the direction 302 and the direction 304 from the first face 202 with the lateral direction and the vertical direction 306 from the second face 206, respectively.

Referring back to the example of FIG. 1A, the process 100 may include a bounding component 112 determining a first bounding shape (e.g., a first bounding box) associated with the first face and a second bounding shape (e.g., a second bounding box) associated with the second face. As described herein, in some examples, a bounding shape may include dimensions in at least three directions, such as the x-direction, the y-direction, and the z-direction. Additionally, in some examples, the bounding shapes may be generated such that they include the same portions of the characters associated with the faces (e.g., the heads, necks, and/or other portions). The bounding component 112 may then scale the first face with respect to the second face using the bounding shapes. For instance, the bounding component 112 may scale the first face with respect to the second face by aligning the first bounding shape with respect to the second bounding shape.

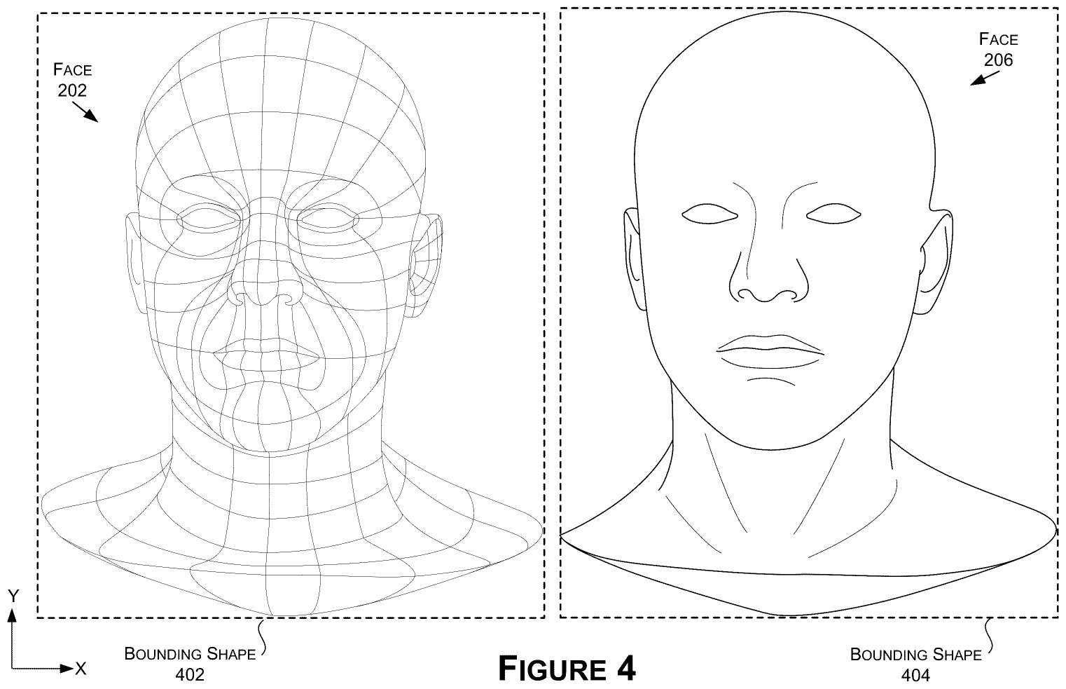

For instance, FIG. 4 illustrates an example of aligning the first face 202 with respect to the second face 206 using bounding shapes, in accordance with some embodiments of the present disclosure. As shown by the example of FIG. 4, the bounding component 112 may determine a first bounding shape 402 associated with the first face 202 and a second bounding shape 404 associated with the second face 206. While the example of FIG. 4 illustrates the bounding shapes 402 and 404 as being two-dimensional, such as by having dimensions in the x-direction and the y-direction, the bounding shapes 402 and 404 may be three-dimensional based on the bounding shapes further including dimensions in the z-direction. In some examples, the bounding component 112 may determine one or more of the bounding shapes 402 and 404 using one or more models. In some examples, the bounding component 112 may determine one or more of the bounding shapes 402 and 404 using one or more inputs from the user(s).

The bounding component 112 may then align the first face 202 with respect to the second face 206 using the bounding shapes 402 and 404. For example, the bounding component 112 may align the first face 202 with respect to the second face 206 by changing the scale of the first bounding shape 402 to substantially match the scale of the second bounding shape 404. As such, since the first bounding shape 402 includes a same portion of the first character associated with the first face 202 as the second bounding shape 404 includes of the second character associated with the second face 206, after performing the alignment, the first face 202 should be scaled to the second face 206.

Referring back to the example of FIG. 1A, the process 100 may include the user device(s) 110 providing input data 108 representing one or more “marker” locations of one or more of the landmarks associated with the second face. For example, a user may be provided with a user interface that depicts are least the first face, the location(s) of the landmark(s) on the first face, and the second face. The user may then use the user interface to indicate the corresponding location(s) of the landmark(s) on the second face. For example, if the user interface indicates a location of a landmark that is associated with a nose of the first face, then the user may provide an input indicating the location of the nose on the second face. In some examples, a number of marker locations may be determined based at least on one or more factors. For instance, the number of marker locations may be determined based at least on user input (e.g., indicating the number of marker locations), a type of the second face, and/or any other factor. For example, if the two faces include a same type of face, such as human faces, then a first number of marker locations may be used. However, if the two faces include different types of faces, such as a human face and a cartoon face, then a second, greater number of marker locations may be used. In some embodiments, in addition to or alternatively from user input to a UI, the landmark updates may be performed automatically using a trained model or algorithm, that analyzes the projected landmarks and shifts them to identified feature points (e.g., left edge of eye, right edge of eye, point of nose, etc.).

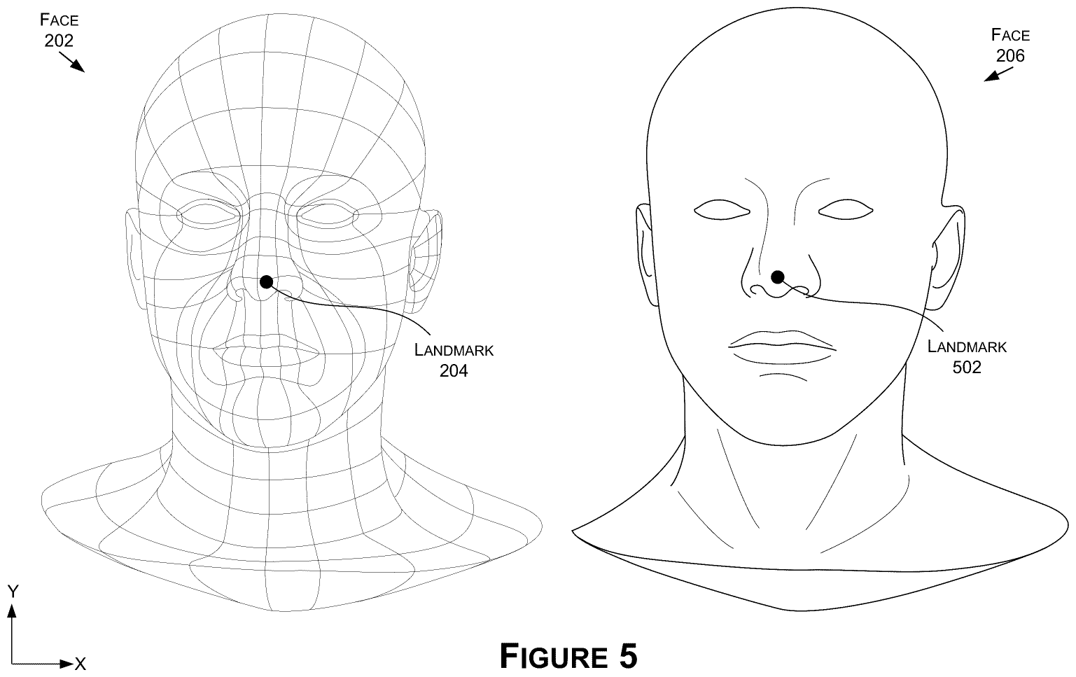

For instance, FIG. 5 illustrates an example of indicating one or more marker locations associated with one or more landmarks on the second face 206, in accordance with some embodiments of the present disclosure. As shown by the example of FIG. 5, a user may be provided with the first face 202 that indicates a location of at least one landmark 204. While the example of FIG. 5 illustrates the location of a single landmark 204, in other examples, the user may be provided with any number of landmark locations. For example, the user may be provided one landmark location, two landmark locations, five landmark locations, ten landmark locations, and/or the like. The user may then indicate a location of a landmark 502 on the second face 206 that correspond the landmark 204. As described in more detail herein, other components (e.g., a transformation component 114, a fitting component 116, etc.) may then use this initial location of the landmark 502 to morph the first face 202 to be similar to the second face 206.

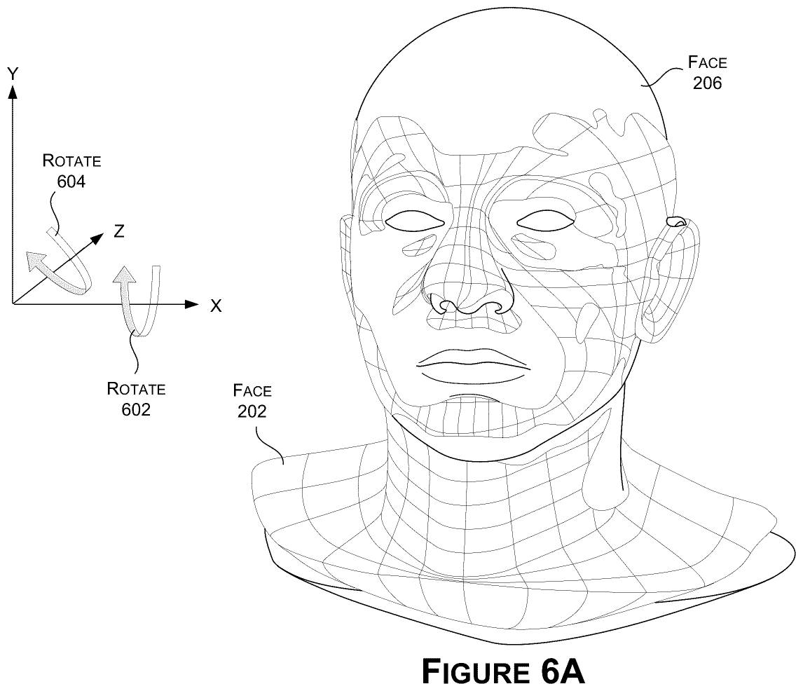

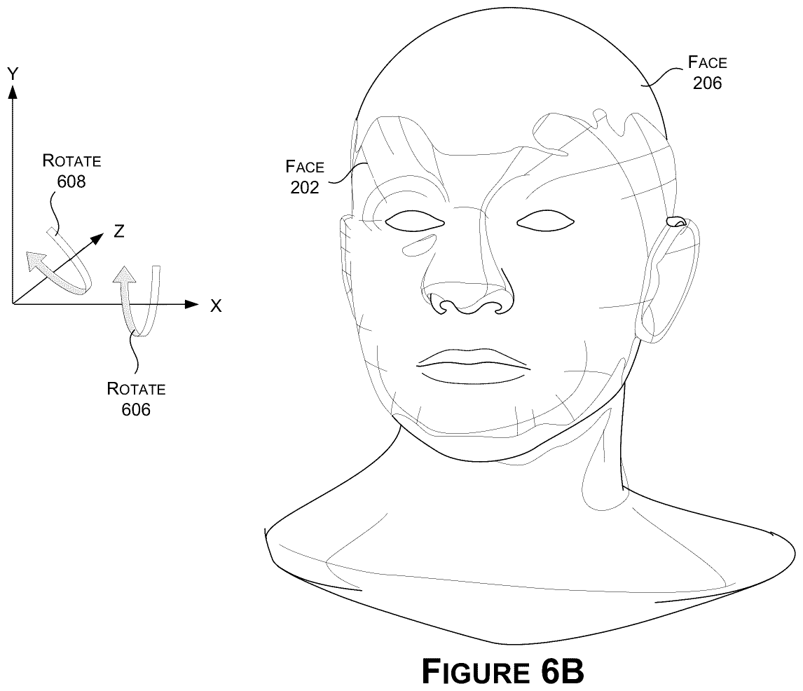

For instance, and referring back to the example of FIG. 1A, the process 100 may include the transformation component 114 performing rigid transformation where the first face is translated, rotated, and/or scaled to better represent the second face. As described herein, translation may include rotating the first face with respect to a first coordinate direction, such as the x-coordinate direction in the example of FIGS. 6A-6B, such that the first face is rotated to match the second face in the first coordinate direction. Additionally, rotation may include rotating the first face with respect to a second coordinate direction, such as the z-coordinate direction in the example of FIGS. 6A-6B, such that the first face is rotated to match the second face in the second coordinate direction. Furthermore, scaling may include changing a size of the first face such that the first face better matches the size of the second face.

In some examples, the transformation component 114 may use one or more functions to perform the rigid transformation. For instance, the transformation component 114 may perform rigid transformation using the following function:

$$E = {\sum }_{i} {‖ pp d ( {p}_{i} , {q}_{i} , {n}_{i} ) ‖}_{2} \qquad ( 1 )$$

As shown, function (1) performs rigid transformation by computing the optimal rotation, optimal translation, and optimal scale that minimizes the energy function E. For instance, ppd( ) is a point-to-plane distance between a point pᵢ on the second face and a point qᵢ on the first face, and nᵢ is a vertex normal direction from the point qᵢ. Additionally, i may include the corresponding point index, such as the closest point, which may be given by the kd-tree search of the closest point.

For example, and for a point qᵢ on the first face, the transformation component 114 may find a closet point pᵢ on the second face using one or more techniques. The transformation component 114 may then determine a first normal vector associated with the point pᵢ and a second vector from the point pᵢ to the point qᵢ. Additionally, the transformation component 114 may determine a dot product between the vectors. In some examples, if the vectors include a similar direction, then the dot product of the two vectors may be close a first value, such as 1. Additionally, if the vectors include orthogonal directions, then the dot product of the two vectors may be close to a second value, such as 0. As such, when the vectors are similar to each other, the impact of the vertex pair on function (1) is greater than if the vectors are orthogonal. The transformation component 114 may then use the points to minimize the energy function E.

The process 100 may also include the fitting component 116 updating the structure of the first face to better represent the second face. For instance, the fitting component 116 may update one or more locations of one or more points (e.g., one or more vertices) of the first face in order to match one or more points (e.g., one or more vertices) of the second face. In some examples, the fitting component 116 may use one or more functions when updating the structure of the first face, such as the following:

$${min}_{a} {\sum }_{i} {‖ W ( {p}_{i} - {( m + U a )}_{i} ) ‖}_{2} \qquad ( 2 )$$

In function (2), pᵢ is again a point on the second face and (m+Ua)ᵢ is the face reconstruction performed by the fitting component 116 on the first face. Additionally, i may include the corresponding point index, such as the closest point, which may be given by the kd-tree search of the closest point. Furthermore, W is a per-correspondence weighting matrix that weighs the point distance error based at least on a vertex normal direction. In other words, function (2) is minimizing the distances between the points on the first face and the points on the second face.

For example, and for a point qᵢ on the first face, the fitting component 116 may find a closet point pᵢ on the second face using one or more techniques. The fitting component 116 may then determine a first normal vector associated with the point pᵢ and a second vector from the point pᵢ to the point qᵢ. Additionally, the fitting component 116 may determine a dot product between the vectors. In some examples, if the vectors include a similar direction, then the dot product of the two vectors may be close a first value, such as 1. Additionally, if the vectors include orthogonal directions, then the dot product of the two vectors may be close to a second value, such as 0. As such, when the vectors are similar to each other, the impact of the vertex pair on function (2) is greater than if the vectors are orthogonal. The fitting component 116 may then use the included points to minimize the distances between the points on the first face and the points on the second face.

As further illustrated in the example of FIG. 1A, the process 100 may continue to repeat between the transformation component 114 performing the rigid transformation and the fitting component 116 performing the updating of the first face for a number of iterations. In some examples, the process 100 may use a set number of iterations such as, but not limited to, one iteration, two iterations, five iterations, ten iterations, and/or any other number of iterations. In some examples, the number of iterations may be based on the results associated with function (1) and/or function (2). For example, the transformation component 114 may continue to perform rigid transformation and/or the fitting component 116 may continue to update the first face until the error E of function (1) satisfies (e.g., is less than or equal to) a threshold error (which may be represented by threshold data 118) and/or until the function (2) satisfies (e.g., is less than or equal to) a threshold (which may also be represented by threshold data 118). In any example, after performing these processes, the landmarks locations on the first face may substantially correspond to the landmark locations on the second face. For example, the translation, the rotation, the scale, and/or the shape of the first face may be taken into account such that the landmarks substantially match on the second face due to the translation, the rotation, the scale, and/or the shape of the second face.

For instance, FIGS. 6A-6B illustrate examples of performing multiple iterations of rigid transformation and structure fitting to cause the first face 202 to better represent the second face 206, in accordance with some embodiments of the present disclosure. As shown by the example of FIG. 6A, during a first iteration, the transformation component 114 may rotate 602 the first face 202 with respect to a first coordinate direction, such as the x-coordinate direction, such that the first face 202 is rotated to match the second face 206 in the first coordinate direction. Additionally, the transformation component 114 may rotate 604 the first face 202 with respect to a second coordinate direction, such as the z-coordinate direction, such that the first face 202 is rotated to match the second face 206 in the second coordinate direction. Furthermore, the transformation component 114 may update a scale of the first face 202 such that the first face 202 better matches the size of the second face 206.

The fitting component 116 may then update the structure of the first face 202 to better represent the second face 206. For instance, the fitting component 116 may update one or more locations of one or more points (e.g., one or more vertices) of the first face 202 in order to match one or more points (e.g., one or more vertices) of the second face 206. As shown by the example of FIG. 6A, after the transformation component 114 performs the rigid transformation on the first face 202 and the fitting component 116 updates the structure of the first face 202, the first face 202 may begin to match the second face 206. For instance, areas that are smooth without contour lines may indicate that the first face 202 matches the second face 206 while areas that include the contour lines may need more updating such that the first face 202 better matches the second face 206.

For instance, and as shown by the example of FIG. 6B, during a second iteration, the transformation component 114 may again rotate 606 the first face 202 with respect to the first coordinate direction, such as the x-coordinate direction, such that the first face 202 is rotated to better match the second face 206 in the first coordinate direction. Additionally, the transformation component 114 may again rotate 608 the first face 202 with respect to the second coordinate direction, such as the z-coordinate direction, such that the first face 202 is rotated to better match the second face 206 in the second coordinate direction. Furthermore, the transformation component 114 may again update the scale of the first face 202 such that the first face 202 better matches the size of the second face 206.

The fitting component 116 may then update the structure of the first face 202 to better represent the second face 206. For instance, the fitting component 116 may update one or more locations of one or more points (e.g., one or more vertices) of the first face 202 in order to match one or more points (e.g., one or more vertices) of the second face 206. As shown by the example of FIG. 6B, after the transformation component 114 performs the rigid transformation on the first face 202 and the fitting component 116 updates the structure of the first face 202, the first face 202 may begin to better match the second face 206. For instance, again areas that are smooth without contour lines may indicate that the first face 202 matches the second face 206 while areas that include the contour lines may need more updating such that the first face 202 better matches the second face 206. As such, since there are less areas that includes the contour lines, the first face 202 in the example of FIG. 6B may better represent the second face 206.

As described herein, the transformation component 114 may continue performing the rigid transformation and/or the fitting component 116 may continue performing the updating of the first face 202 for a number of iterations. In some examples, the transformation component 114 and/or the fitting component 116 may use a set number of iterations such as, but not limited to, one iteration, two iterations, five iterations, ten iterations, and/or any other number of iterations. In some examples, the number of iterations may be based on the results associated with function (1) and/or function (2). For example, the transformation component 114 may continue to perform rigid transformation and/or the fitting component 116 may continue to update the first face 202 until the error E of function (1) satisfies (e.g., is less than or equal to) a threshold error and/or until the function (2) satisfies (e.g., is less than or equal to) a threshold. In any example, after performing these processes, the first face 202 may substantially represent the second face 206. For example, the translation, the rotation, the scale, and/or the shape of the first face 202 may substantially match the translation, the rotation, the scale, and/or the shape of the second face 206.

Referring back to the example of FIG. 1A, the process 100 may include a landmark component 120 determining the locations of the landmarks on the second face using the locations of the landmarks on the first face. As described herein, the landmarks may be associated with features of the second face such as, but not limited to, one or more eye features (e.g., the tops of the eyes, the bottoms of the eyes, the sides of the eyes, the middles of the eyes), one or more lip features (e.g., the top of the lips, the bottom of the lips, the sides of the lips, the middle of the lips, etc.), one or more cheek features, one or more nose features, one or more ear features, one or more chin features, and/or any other features of a face. In some examples, the landmark component 120 may use one or more techniques for determining the locations of the landmarks on the second face.

For example, and for a landmark, the landmark component 120 may identify a closest point on the second face that matches a point associated with the landmark on the first face. The landmark component 120 may then determine a first normal direction of a first vertex associated with the point on the first face and a second normal direction of a second vertex associated with the closest point on the second face. Additionally, the landmark component 120 may then determine whether the second normal direction is similar to the first normal direction. In some examples, the landmark component 120 may determine that the second normal direction is similar to the first normal direction based at least on the second normal direction satisfying (e.g., being less than or equal to) a threshold angle (e.g., 10 degrees, 30 degrees, 45 degrees, 70 degrees, etc.) (which is represented by threshold data 118) from the first normal direction or determine that the second normal direction is not similar to the first normal direction based at least on the second normal direction not satisfying (e.g., being greater than) the threshold angle from the first normal direction.

If the landmark component 120 determines that the second normal direction is similar to the first normal direction, then the landmark component 120 may determine that a location on the second face that is associated with the closest point includes the landmark. However, if the landmark component 120 determines that the second normal direction is not similar to the first normal direction, then the landmark component 120 may determine a next closest point on the second face to the point on the first face. Additionally, the landmark component 120 may perform similar processes to determine whether a third normal direction associated with the second closest point is similar to the first normal direction. The landmark component 120 may then continue to perform these processes until finding the location of the landmark on the second face that matches the location of the landmark on the first face. Additionally, the landmark component 120 may perform these processes for one or more (e.g., each of the) additional landmarks.

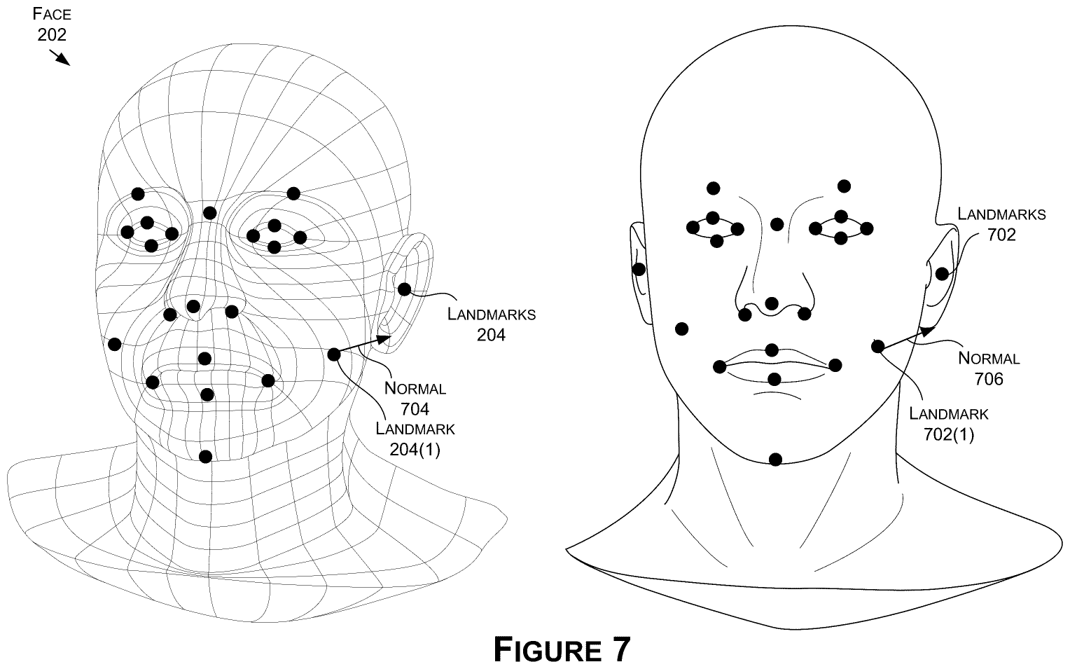

For instance, FIG. 7 illustrates an example of determining landmark locations on the second face 206 using landmark locations on the first face 202, in accordance with some embodiments of the present disclosure. As shown, the landmark component 120 may perform one or more of the processes described herein to determine locations of landmarks 702 (although only a few are labeled for clarity reasons) on the second face 206 using the locations of the corresponding landmarks 204 (although only a few are again labeled for clarity reasons) on the first face 202. For instance, and for a landmark 204(1), the landmark component 120 may initially identify a point on the second face 206 that includes a closest point to a point on the first face 202 that is associated with the location of the landmark 204(1). The landmark component 120 may then determine a first normal direction 704 associated with the point on the first face 202 and a second normal direction 706 associated with the point on the second face 206. Additionally, the landmark component 120 may determine whether the second normal direction 706 is similar to the first normal direction 704.

As described herein, if the landmark component 120 determines that the second normal direction 706 is not similar to the first normal direction 704 (e.g., the second normal direction 706 is greater than a threshold angle from the first normal direction 704), then the landmark component 120 may identify a next closest point on the second face 206. However, and as illustrated by the example of FIG. 7, if the landmark component 120 determines that the second normal direction 706 is similar to the first normal direction 704 (e.g., the second normal direction 706 is less than or equal to the threshold angle from the first normal direction 704), then the landmark component 120 may determine that a location of the point on the second face 206 includes a landmark 702(1) that corresponds to the landmark 204(1). The landmark component 120 may then perform similar processes for one or more (e.g., each) of the other landmarks 204.

Referring back to the example of FIG. 1A, the process 100 may include outputting updated face data 122 representing the locations of the landmarks on the second face. In some examples, the user device(s) 110 may then use the updated face data 122 to display the second face along with the locations of the landmarks to one or more users. For example, the user device(s) 110 may display the second face 206 along with the locations of the landmarks 702 from the example of FIG. 7 to the user(s). The user(s) may then be able determine whether the locations of the landmarks are correct and/or update one or more of the locations if the location(s) is not correct.

Referring now to the example of FIG. 1B, FIG. 1B illustrates an example data flow diagram for a process 124 of interactively identifying landmark locations on faces, in accordance with some embodiments of the present disclosure. As shown, the process 124 of FIG. 1B may be similar to the process 100 of FIG. 1A, except that the process 124 may include the user device(s) 110 providing marker input data 126 representing one or more “marker” locations of one or more landmarks associated with the second face and then a deform component 128 performing an initial deformation of the first face based at least on the marker location(s) of the landmark(s). As such, in some examples, the process 124 may better determine landmark locations on certain types of faces, such as faces (e.g., cartoon faces) that include one or more additional and/or alternative features and/or different and/or alternative feature proportions as compared to the first face represented by the face data 104.

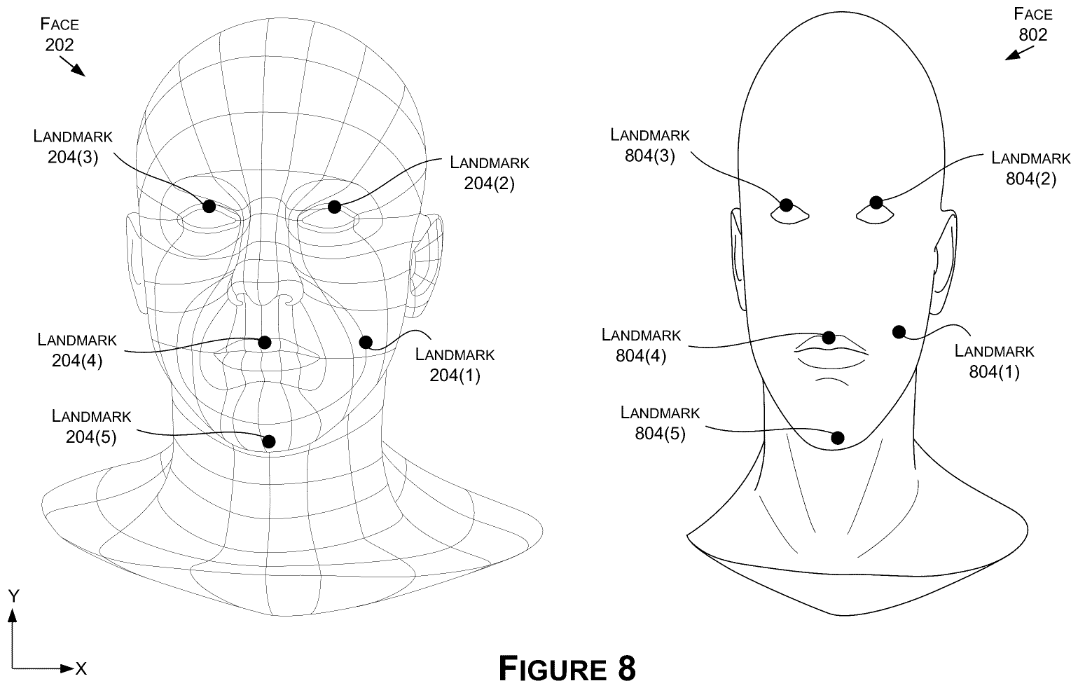

For instance, FIG. 8 illustrates an example of indicating marker locations associated with landmarks on a face, in accordance with some embodiments of the present disclosure. As shown in the example of FIG. 8, a second face 802 now includes a cartoon without one or more features of the first face 202, such as the nose. As such, a user may want to provide additional marker locations associated with the second face 802 in order for the rest of the process 124 to better match the first face 202 to the second face 802. In the example of FIG. 8, the user may be provided with the first face 202 that indicates locations of at least five landmarks 204(1)-(5). While the example of FIG. 8 illustrates the locations of the five landmarks 204(1)-(5), in other examples, the user may be provided with any number of landmark locations. For example, the user may be provided one landmark location, two landmark locations, five landmark locations, ten landmark locations, and/or the like.

The user may then identify locations of landmarks 804(1)-(5) on the second face 802 that correspond to the locations of the landmarks 204(1)-(5) on the first face 202. For instance, the user may indicate that the location of the landmark 804(1) corresponds to the location of the landmark 204(1), the location of the landmark 804(2) corresponds to the location of the landmark 204(2), the location of the landmark 804(3) corresponds to the location of the landmark 204(3), the location of the landmark 804(4) corresponds to the location of the landmark 204(4), and the location of the landmark 804(5) corresponds to the location of the landmark 204(5). In some examples, the user may indicate the locations of the landmarks 804(1)-(5) using one or more techniques, such as selecting the locations on the second face 802, moving the markers to the correct locations on the second face 802, and/or using any other technique.

Referring back to the example of FIG. 1B, the deform component 128 may then use the marker locations to deform the first face to more similarly match the second face. In some examples, the deform component 128 may deform the first face by updating at least the vertices associated with the locations of the landmarks on the first face to more closely match the marker locations on the second face. In some examples, the deform component 128 may use one or more functions to perform the deformation of the first face. For example, the deform component 128 may deform the first face using the following function:

$${p}_{i} = R ( {q}_{i} ) \qquad ( 3 )$$

In function (3), a deformation function R may be trained using landmark correspondences between points pᵢ on the first face and points qᵢ on the second face. The deform component 128 may then deform one or more (e.g., all) of the points on the first face using the trained deformation function R. In some examples, the deform component 128 may further use a function, such as a Thin Plate Spline (TPS) (and/or any other function), as a kernel function that minimizes the bending energy of the deformation. For instance, the deform component 128 may use the following function:

$$U ( x , {p}_{i} ) = ‖ x - {p}_{i} ‖ \qquad ( 4 )$$

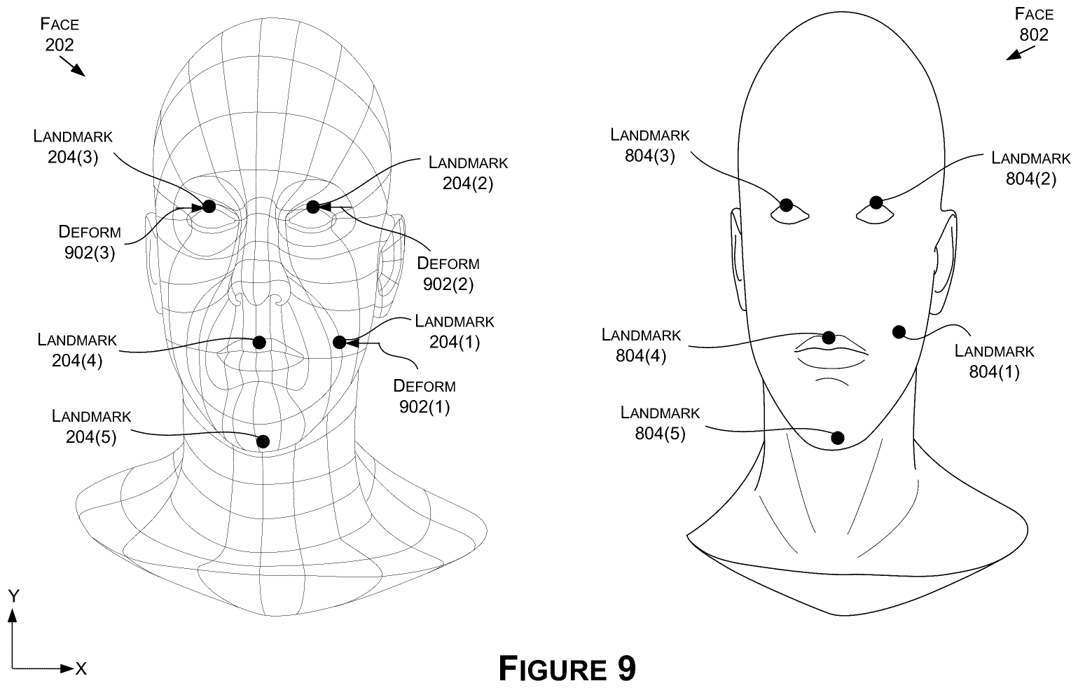

For instance, FIG. 9 illustrates an example of using marker locations to deform the first face 202 to represent the second face 802, in accordance with some embodiments of the present disclosure. As shown, the deform component 128 may deform the first face 202 by moving one or more vertices based at least on the locations of the landmarks 804(1)-(5) as indicated by the user, where the deformation is indicated at least by arrows 902(1)-(3). As such, by performing such deformation, the first face 202 looks more similar to the second face 802.

Referring back to the example of FIG. 1B, after performing the deformation, the process 124 may again be similar to the process 100 by the transformation component 114 performing rigid transformation, the fitting component 116 updating the structure of the first face to better represent the second face, the landmark component 120 determining the locations of the landmarks on the second face, and the outputting of the updated face data 122 representing the locations of the landmarks on the second face.

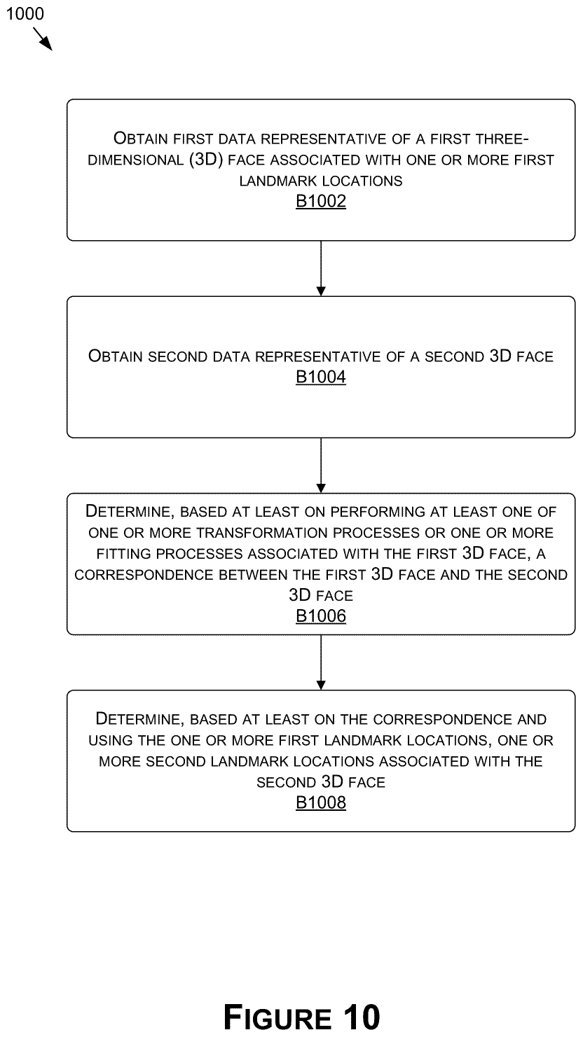

Now referring to FIG. 10, each block of method 1000, described herein, comprises a computing process that may be performed using any combination of hardware, firmware, and/or software. For instance, various functions may be carried out by a processor executing instructions stored in memory. The method 1000 may also be embodied as computer-usable instructions stored on computer storage media. The method 1000 may be provided by a standalone application, a service or hosted service (standalone or in combination with another hosted service), or a plug-in to another product, to name a few. In addition, method 1000 is described, by way of example, with respect to FIGS. 1A and 1B. However, this method 1000 may additionally or alternatively be executed by any one system, or any combination of systems, including, but not limited to, those described herein.

FIG. 10 illustrates a flow diagram showing a method 1000 for identifying landmark locations on faces, in accordance with some embodiments of the present disclosure. The method 1000, at block B1002, may include obtaining first data representative of a first three-dimensional (3D) face associated with one or more first landmark locations. For instance, a system(s) may receive the face data 104 representing the first face. As described herein, the first face may correspond to a morphable model face where the first landmark location(s) is already known, such as by using user input, machine learning, and/or any other technique for determining landmark locations on faces. Additionally, the landmark(s) may be associated with one or more features of the first face such as, but not limited to, one or more eye features (e.g., the tops of the eyes, the bottoms of the eyes, the sides of the eyes, the middles of the eyes), one or more lip features (e.g., the top of the lips, the bottom of the lips, the sides of the lips, the middle of the lips, etc.), one or more cheek features, one or more nose features, one or more ear features, one or more chin features, and/or any other features.

The method 1000, at block B1004, may include obtaining second data representative of a second 3D face. For instance, the system(s) may also receive the face data 106 representing the second face. In some examples, the second face may include a similar structure as the first face. For example, the second face and the first face may both include similar features, such as mouths, eyes, noses, chins, cheeks, ears, and/or so forth. However, in other examples, the second face may include a different structure as compared to the first face. For example, the second face may include additional, less, and/or alternative features as compared to the first face and/or may include different feature proportions as compared to the first face.

The method 1000, at block B1006, may include determining, based at least on performing at least one of one or more transformation processes or one or more fitting processes associated with the first 3D face, a correspondence between the first 3D face and the second 3D face. For instance, the system(s) may process the first face using at least the transformation component 114 and/or the fitting component 116, such as by using one or more iterations. In some examples, the system(s) may further process the first face using the orientation component 102, the bounding component 112, and/or the deform component 128. Based at least on the processing, the system(s) may determine the correspondence between the first face and the second face. As described herein, the correspondence may be associated with morphing the first face to be similar in size, pose, scale, etc. to the second face.

The method 1000, at block B1008, may include determining, based at least on the correspondence and using the one or more first landmark locations, one or more second landmark locations associated with the second 3D face. For instance, the system(s) may process the first face and the second face using the landmark component 120 to determine the second landmark location(s) based at least on the correspondence and the first landmark location(s). As described herein, the landmark component 120 may determine the second landmark location(s) based at least on one or more closest points associated with the first landmark location(s) and/or one or more surface normal directions associated with the closest point(s). In some examples, the system(s) may further verify the results of the second landmark location(s), such as by using feedback from one or more users.

In any embodiment, once the landmark points have been transferred from the first face to the second face, various operations may be performed using the transferred landmark points. For example, facial retargeting may be used to transfer animations learned for the first face to the second face without requiring additional programming or learning for the second face in particular (although additional learning/training may be performed for the second face, with the retargeting serving as a head start). In other examples, the transfer of the landmark points may help with animating various different types of avatars, characters, non-player characters, etc., that may have great deviation in appearances, without requiring separately learning each different facial structure, layout, feature types, etc. As such, facial landmarks from one face, or one class of faces, may be quickly transferred to other faces in order to expedite the facial animation processes for the transferred or target faces. These animations may be used for avatars, characters, etc. in any use case, such as gaming applications, video conferencing applications, metaverse/omniverse applications, and/or the like.

### Example Computing Device

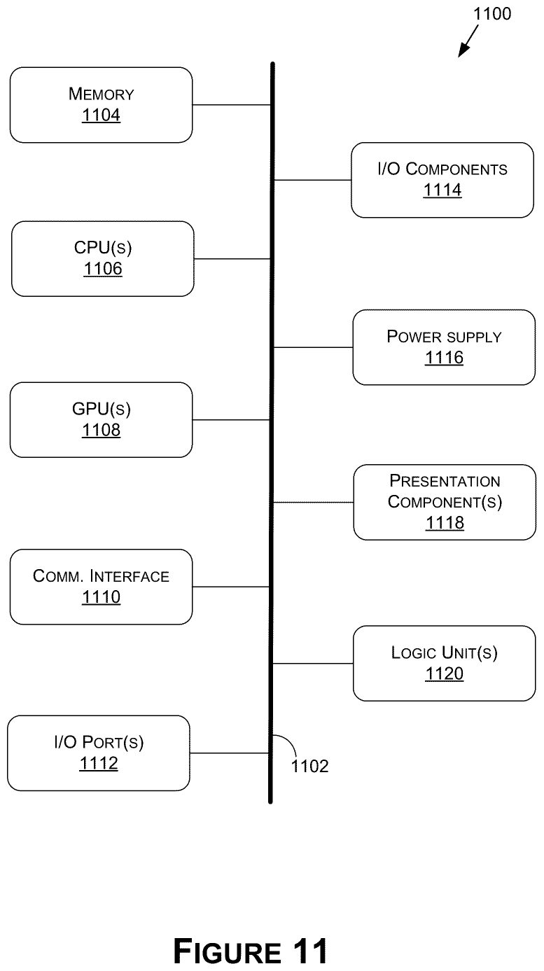

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

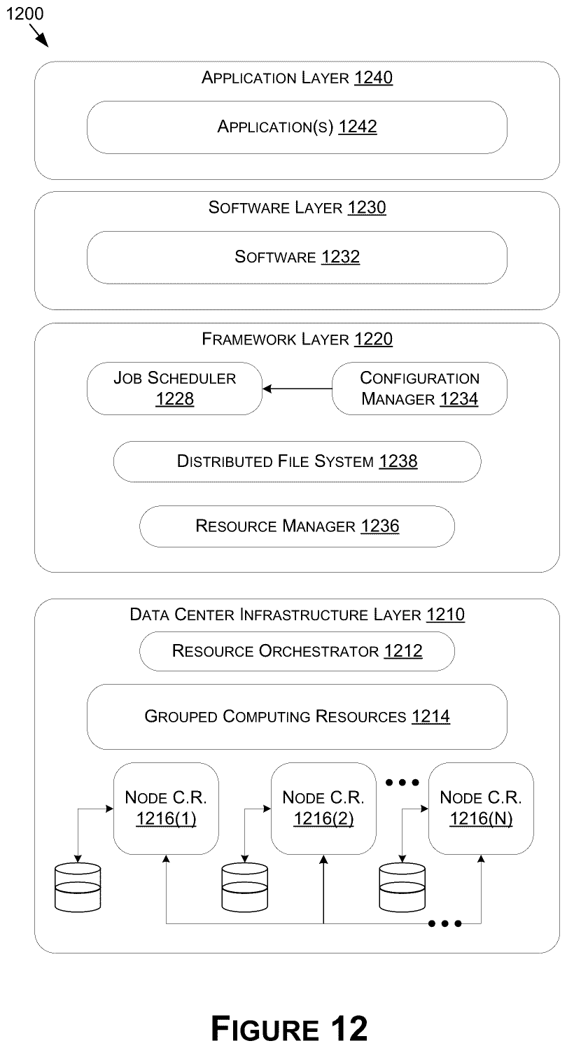

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161 (N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216 (N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
obtaining first data corresponding to a first three-dimensional (3D) face and one or more first landmark locations corresponding to the first 3D face;
obtaining second data corresponding to a second 3D face;
determining, based at least on performing at least one of one or more transformation processes associated with the first 3D face or one or more fitting processes associated with the first 3D face, a correspondence between the first 3D face and the second 3D face; and
determining, based at least on the correspondence and using the one or more first landmark locations, one or more second landmark locations associated with the second 3D face; and
performing one or more animation operations with respect to the second 3D face based at least on the one or more second landmark locations.

2. The method of claim 1, wherein the performing the at least one of the one or more transformation processes associated with the first 3D face or the one or more fitting processes associated with the first 3D face comprises:
performing a transformation process of the one or more transformation processes by at least updating at least one of a rotation, a translation, or a scale associated with the first 3D face; and
performing a fitting process of the one or more fitting processes by at least updating a shape of the first 3D face.

3. The method of claim 2, wherein the performing the fitting process occurs after the performing the transformation process, and wherein the performing the at least one of the one or more transformation processes associated with the first 3D face or the one or more fitting processes associated with the first 3D face further comprises:
after the performing the fitting process, performing a second transformation process of the one or more transformation processes by at least further updating at least one of the rotation, the translation, or the scale associated with the first 3D face; and
after the performing the second transformation process, performing a second fitting process by at least further updating the shape of the first 3D face.

4. The method of claim 1, further comprising:
receiving input data indicating that a third landmark location associated with the first 3D face corresponds to a fourth landmark location associated with the second 3D face,
wherein the determining the correspondence is further based at least on the input data.

5. The method of claim 1, further comprising:
receiving input data indicating that one or more third landmark locations associated with the first 3D face correspond to one or more fourth landmark locations associated with the second 3D face; and
updating, based at least on the one or more third landmark locations corresponding to the one or more fourth landmark locations, one or more points of the first 3D face that are associated with the one or more third landmark locations,
wherein the determining the correspondence is further based at least on the updating of the one or more points.

6. The method of claim 1, further comprising:
determining a first orientation associated with the first 3D face; and
determining, based at least on the first orientation, a second orientation associated with the second 3D face such that the second 3D face is substantially oriented with respect to the first 3D face,
wherein the determining the correspondence is further based at least on the first orientation and the second orientation.

7. The method of claim 1, further comprising:
determining a first bounding shape associated with the first 3D face;
determining a second bounding shape associated with the second 3D face; and
aligning, based at least on the first bounding shape and the second bounding shape, the first 3D face with respect to the second 3D face,
wherein the determining the correspondence is further based at least on the aligning of the first 3D shape with respect to the second 3D shape.

8. The method of claim 1, wherein the determining the one or more second landmark locations associated with the second 3D face comprises:
determining, based at least on the correspondence and using a first landmark location of the one or more first landmark locations, a potential landmark location associated with the second 3D face;
determining a first surface normal angle associated with the first landmark location and a second surface normal location associated with the potential landmark location;
determining that the first surface normal angle is within a threshold angle to the second surface normal angle; and
based at least on the first surface normal angle being within the threshold angle to the second surface normal angle, determining that the potential landmark location includes a second landmark location of the one or more second landmark locations.

9. The method of claim 1, wherein the performing the at least one of the one or more transformation processes associated with the first 3D face or the one or more fitting processes associated with the first 3D face uses at least one of:
one or more distances between one or more first points associated with the first 3D face and one or more second points associated with the second 3D face; or
one or more first surface normal angles associated with the one or more first points and one or more second surface normal angles associated with the one or more second points.

10. The method of claim 1, wherein:
the one or more first landmark locations include one or more first locations of one or more facial features associated with the first 3D face; and
the one or more second landmark locations include one or more second locations of the one or more facial features associated with the second 3D face.

11. A system comprising:
one or more processing units to:
determine, based at least on performing at least one of one or more transformation processes associated with a first three-dimensional (3D) face or one or more fitting processes associated with the first 3D face, a correspondence between the first 3D face and a second 3D face;
determine one or more first locations of one or more features associated with the first 3D face; and
determining, based at least on the correspondence and the one or more first locations, one or more second locations of the one or more features associated with the second 3D face.

12. The system of claim 11, wherein the performance of the at least one of the one or more transformation processes associated with the first 3D face or the one or more fitting processes associated with the first 3D face comprises:
performing a transformation process of the one or more transformation processes by at least updating at least one of a rotation, a translation, or a scale associated with the first 3D face; and
performing a fitting process of the one or more fitting processes by at least updating a shape of the first 3D face.

13. The system of claim 12, wherein the performing the fitting process occurs after the performing the transformation process, and wherein the performance of the at least one of the one or more transformation processes associated with the first 3D face or the one or more fitting processes associated with the first 3D face further comprises:
after the performing the fitting process, performing a second transformation process of the one or more transformation processes by at least further updating at least one of the rotation, the translation, or the scale associated with the first 3D face; and
after the performing the second transformation process, performing a second fitting process by at least further updating the shape of the first 3D face.

14. The system of claim 11, wherein the one or more processing units are further to:
receive input data indicating that a third location of a second feature associated with the first 3D face corresponds to a fourth location of the second feature associated with the second 3D face,
wherein the correspondence is further determined based at least on the input data.

15. The system of claim 11, wherein the one or more processing units are further to:
receive input data indicating that one or more third locations of one or more second features associated with the first 3D face correspond to one or more fourth locations of the one or more second features associated with the second 3D face; and
update, based at least on the one or more third locations corresponding to the one or more fourth locations, one or more points associated with the one or more second features on the first 3D face to determine one or more updated points,
wherein the correspondence is further determined based at least on the one or more updated points.

16. The system of claim 11, wherein the one or more processors are further to:
determine a first orientation associated with the first 3D face; and
determine, based at least on the first orientation, a second orientation associated with the second 3D face such that the second 3D face is substantially oriented with respect to the first 3D face,
wherein the correspondence is further determined based at least on the first orientation and the second orientation.

17. The system of claim 11, wherein the determination of the one or more second locations of the one or more features associated with the second 3D face comprises:
determining, based at least on the correspondence and using a first location of the one or more first locations, a potential location of a feature of the one or more features associated with the second 3D face;
determining a first surface normal angle associated with the first location and a second surface normal location associated with the potential location;
determining that the first surface normal angle is within a threshold angle to the second surface normal angle; and
based at least on the first surface normal angle being within the threshold angle to the second surface normal angle, determining that the potential location includes a second location of the one or more second locations for the feature.

18. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs)
a system for performing generative AI operations;
a system for generating synthetic data;
a system incorporating one or more virtual machines (VMs)
a system implemented at least partially in a data center; or
a system implemented at least partially using cloud computing resources.

19. A processor comprising:
one or more processing units to determine one or more first landmark locations associated with a first three-dimensional (3D) face using one or more second landmark locations associated with a second 3D face that is processed to align with the first 3D face, wherein the second 3D face is processed to align with the first 3D face based at least on performing one or more transformation processes and one or more fitting processes.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs)
a system for generating synthetic data;
a system for performing generate AI operations;
a system incorporating one or more virtual machines (VMs)ᵢ
a system implemented at least partially in a data center; or
a system implemented at least partially using cloud computing resources.
